(19) United States
(12) Patent Application Publication
(10) Pub. No.: US 2011/0231343 A1
(43) Pub. Date: Sep. 22, 2011

(54) Method utilizing private bifurcated counter-balancing risk pools to reduce a public sanitation authority's financial and legal liability caused by defective, privately-owned sewer lateral service lines

(76) Inventor: Richard Samuel Zizian, San Diego, CA (US)

(21) Appl. No.: 12/661,518

(22) Filed: Mar. 18, 2010

(51) Int. Cl. G06Q 90/00

(52) U.S. Cl. 705/500

(57) ABSTRACT

A public/private sector cooperative method, and interrelated steps, utilizing a private third-party indemnification pool structure, coupled with a bifurcated, counterbalancing environmental risk pool, to create a community-wide, public inspection program, and a privately-funded maintenance, repair, rehabilitation methodology for inflow/infiltration defective, privately-owned sewer lateral lines, revealed through sewer emergencies or discovered during public inspections. The methodology and steps designed to reduce the financial, legal, public safety, health and environmental risks defective privately-owned sewer lateral service lines create and impose upon public sewer authorities, who have no, or limited, financial or legal jurisdiction over private sewer lines. The pools share counter-balancing risks under defined circumstances and are interchangeable with a variety of funding mechanisms, including but not limited to insurance, reinsurance, reserves, bifurcated premiums, bifurcated fees, corporate guarantees, grants, gifts, contractual liability policies, loss reserves, retrospective profit sharing, experience rated dividends, risk retention, or other similar funding and insuring vehicles.

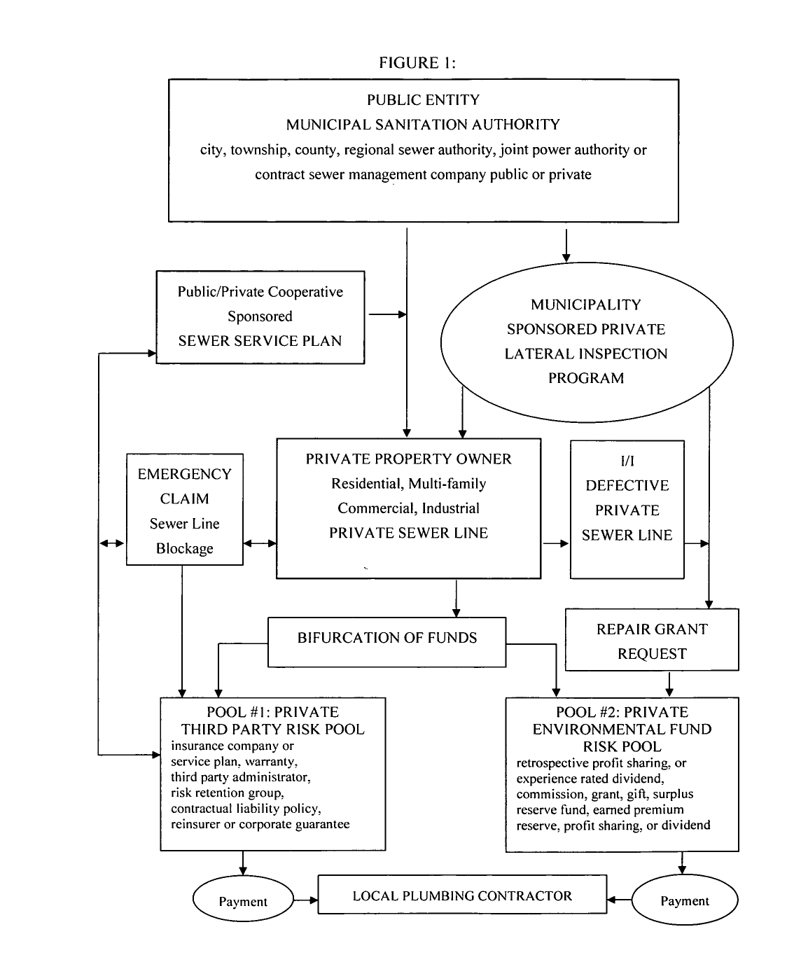

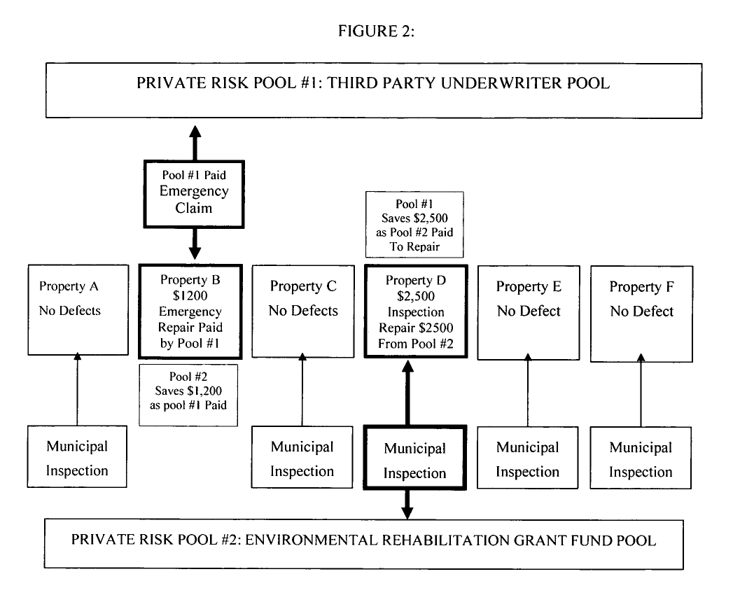

### BACKGROUND OF INVENTION

The United States public waterways, including its streams, rivers, lakes, bays, beaches harbors and oceans, are being contaminated each year with millions of gallons of untreated raw sewage released from public waste treatment facilities. These intentional, and often unavoidable, sewage releases are officially known in governmental vernacular as “SSO's” (sanitary sewer overflows) which include CSO's, (combined sewer overflows). The Environmental Protection Agency estimates that there are as many as 40,000 separate SSO's incidents, per year, in the United States. This is now a national environmental and ecological infrastructure crisis. The average age of our nation's sewer and water lines is estimated to be 75 years old.

SSO discharges normally occur when municipal sewage treatment plants cannot handle the volume of raw sewage arriving at their facilities. On dry weather days, an average community's sewage treatment plant could process, for example, 14 million gallons of sewage per day, however, during wet weather days, the volume can spike to 60 million gallons of sewage per day, which the municipality may not have the ability to handle or process. Modern day sewer systems are not designed or intended to intake rain or ground water. The sewage system is reserved for sewage only, due to the cost and process required to treat sewage. Municipalities should not be spending their beleaguered funds, and consuming wasteful levels of energy on mechanically and chemically treating pure rain and ground water that does not require treatment. The only exceptions are the very old combined systems which are being systematically removed across the country.

To make matters worse, this excess volume of rain and ground water impregnated sewage must be released untreated or partially treated into the adjacent public waterways to avoid sewage floods, back ups into homes, businesses, basements, and streets. If the public treatment facility does not have the capacity to process or store the excess volume, they have no option but to release the sewage untreated. This problem is a major fiscal and environmental focus of local governments and both state and federal environmental protection agency regulators, especially the federal government's Environmental Protection Agency (“EPA”).

Municipalities and sanitary sewer districts are being fined, put under mandatory consent orders and threatened the loss of their licenses to treat sewage if they do not come up with a solution that satisfies state health requirements and particularly, compliance with federal clean water act regulations. Many municipalities across the country are up against fast approaching enforcement agency deadlines to comply, and are facing billions of dollars in fines and penalties

Due to a number of complicated local, state and federal restrictions, no legal or financially viable public or private solution exists today for municipalities to completely harness and control all of the major causes of SSO's. One major barrier arises from the fact that approximately 50% of an average community's sewer infrastructure system is privately-owned by residential and business property owners. Generally, for every mile of public sewer line, there is a corresponding mile of privately-owned sewer lateral service lines. The subject private sewer lines are those that run underground, from the foundation of the building, across the private property, and under the public right-of-way, to the point where it connects to the main public sewer transportation line. The Clean Water Act requirements do not extend to private property owners. Additionally, most municipalities have no authorized financial or legal jurisdiction over private sewer lines. The municipality must therefore put the full financial and legal burden of dealing with private sewer service lines on the private property owner. To complicate matters even further, underground, private sewer lines, external of the building, have always been excluded and afforded no coverage under standard homeowner's insurance policies. Therefore, the property owner is directly responsible for all financial issues relating to his private sewer line. With the average cost nationally of approximately $4,500 to replace a defective sewer lateral, many property owners procrastinate in making necessary repairs despite the negative environmental, financial and legal consequences they are passing on to their local government with the inflow, infiltration and exfiltration defects in their sewer lines. Meeting the state and federal government's legal mandates, in the face of the restrictions on using public funds on private property and the lack of legal jurisdiction to enter private property in many states, will therefore require a public-private sector cooperative solution. The method must provides public sewage treatment authorities with an independent, private-sector financial remedy and method to pay for private sewer line rehabilitation. Sewage flow studies have demonstrated that perhaps 40% or more of the causes of SSO's originate from defective, damaged or worn out sewer lateral lines on private property. In most jurisdictions public funds cannot be used to address private property matters, even if the private property condition is posing significant legal, financial, health and environmental risk to the municipality and its citizens. The invention method described herein, and its interrelated steps, do in fact provide the first, privately-funded, public/private sector cooperative financial and legal method that systematically addresses the heretofore unresolved “private-side” environmental infrastructure crisis caused by inflow/infiltration and exfiltration defective private sewer lateral service lines.

The invention's solution methodology is achieved by a number of uniquely compiled steps which integrate (1) an insured risk pool, (2) a separate environmental rehabilitation grant fund risk pool, operating simultaneously as a risk spreading and risk absorbing counter-balance to the insured risk pool, and (3) a municipality sponsored private sewer lateral inspection program.

One of the major reasons municipalities cannot handle the sewage volume flows that cause and result in SSO's is that at certain times, especially during wet weather conditions, rain and ground water, which should never be in the sanitary sewer system, is entering the deteriorated sewer system infrastructure, on both the public and private side of the system. Most modern-day sewer systems are designed and constructed to transport and process sewage only. Rain and ground water should never enter the sanitary sewer system. The unintended intrusion of rain and ground water into a sewer service line is a problematic condition commonly known as inflow and infiltration, or “I/I.” During wet weather periods, water seeps and pours into the deteriorated sewer pipe infrastructures (cracks, joints, missing parts) and increases the volume of now rain-comingled sewage headed toward the sanitation treatment plant by 100% to 600% in a very short period of time. Many municipalities cannot handle this increased volume all at once, and have no alternative but to discharge the excess volume, which includes untreated raw waste, into our nation's waterways. The term “inflow” is used to describe water entering the sewer system directly. The term “infiltration” is used to describe water entering the sewer system from groundwater or from below-ground level. The expression “I/I” refers to the combined effects of inflow and infiltration. Infiltration enters the sewer system through openings such as displaced or open pipe joints, cracks, fractures and breaks in the fabric of the public and private sewer lateral lines.

Additionally, “exfiltration” is the seeping out of raw sewage from the same displaced or open pipe joints, cracks, fractures and breaks within the public or private sewer lines that can create unhealthy and unsafe bio-contamination of local yards, neighborhoods and subterranean water tables.

The source and root cause of the I/I related problems is that the nation's sewer infrastructure is aging, deteriorated and is failing from one community to the next. It is estimated that half of the nation's sewer lines are beyond their useful life and must be repaired, relined or replaced. Some are over 150 years old, and the average life of a sewer lateral line is rated for only an average life of 20 to 25 years before some maintenance or repair is necessary. Generally, 50% of this failing infrastructure is owned by the municipality in the form of sewage treatment plants, manholes and main sewer lines that transport waste under the center of the street to the publically-owned sewage treatment plant. And, approximately 50% of the failing infrastructure are the private sewer lateral lines owned by private property owners (homes, multi-family, commercial and industrial businesses) that transport the sewage underground, across private property, from the exterior foundation of the building to where it connects to the public sewer main line. In the vast majority of states, the municipality can only use municipal funds to make repairs to the publically-owned portion of the sewer system. Most municipalities cannot use public funds to repair, replace or rehabilitate privately owned sewer lines, and must pass that legal and financial burden onto the private property owner.

Thousands of municipalities have spent billions of dollars of public funds renovating their public sanitation systems, including (1) relining or replacing old main sewer lines, (2) sealing manhole covers to keep water out, and (3) expanding or improving public sewage treatment facilities. Even after complete rehabilitation of the public-side of the system, flow studies conducted after the public-side rehabilitation program have shown only a partial improvement in inflow/infiltration volume reduction. What these studies reveal is that even after rehabilitating the public side of the sewer system, significantly large volumes of I/I water continue to plague their communities because of the I/I entering into the sewage system from the deteriorated privately-owned sewer lateral lines over which the municipality has no repair jurisdiction.

The challenge to the municipality is that they have limited ability to work with private property owners to solve the I/I problem. This legal, financial, health and environmental crisis is challenging to municipal governments for the following reasons:

a. The average national cost to rehabilitate a private residential sewer lateral line is $4,500, which is a significant amount of money to the average property owner. This expenditure often comes unexpectedly, resulting in an emergency-based, financial burden for the private property owner, who may or may not have the available financial resources at the time.

b. Private Property owners are often not aware that they are responsible for maintaining their section of the sewage system.

c. Many private property owners do not know what a sewer lateral line is.

d. No regular sewer line maintenance regime is implemented by the vast majority of private property owners.

e. The defects in the owner's private sewer line are an “out of sight, out of mind” matter.

f. Due to the cost, property owners avoid making the financial commitment to repair their defective lines and procrastinate until the service line becomes completely inoperable.

g. The private sewer line problem has, after decades, now manifested itself into a national environmental and ecological infrastructure crisis of major proportion, much of which is attributed to the fact that traditional homeowner's insurance policies do not afford coverage for exterior, underground sewer and water service lines. The lack of private funds to facilitate the cost of private repairs, other than direct out-of-pocket payment by the property owner, has exacerbated the problem.

h. Some municipalities attempt to conduct city inspections of private lateral lines to seek out I/I defective residential and commercial lateral lines, however, there are private property rights in many states that preclude the city from conducting an inspection on private property without the consent of the property owner. Denied access frequently occurs.

i. Cities have also passed unfunded enforcement ordinances where they fine, restrict the sale of the property, or shut off water to violating properties. None are politically acceptable solutions, when as much as 50% of the I/I problem is the financial burden of the voters who own these defective properties.

To address the legal and financial complexities of this current condition, a methodology must possess all of the following design element steps to address the problem.

a. An insurer or contractual liability administrator to insure a service plan that provides coverage to the property owner for emergency repairs to their sewer lateral lines. The financial challenge of this step is that the underwriter must knowingly and willingly insure in a potentially high-risk, deteriorated municipal jurisdiction with an aging sewer infrastructure (1) at reasonable rates that will encourage property owner participation, and (2) that will yield a reasonable underwriting profit for the underwriting insurance company. Step 2 below provides this methodology.

b. The integration of step 2 with a counter-balancing environmental risk fund provides the insurance underwriter with risk mitigating features that makes the method financially viable for the municipality, the insurer and the covered property owner. The second counter-balancing risk pool (known as the environmental rehabilitation grant fund) reduces the insurance underwriter's actuarial frequency exposure, by paying for private sewer line repairs, relining or replacement through repair grants funded by risk pool #2, before a covered claim arises under the service plan program risk pool #1 in step 1.

c. Risk pool #2, the environmental rehabilitation grant fund is funded by bifurcating a portion of the retail service plan premium and allocating it to a separate, trustee held, non-insurance company affiliated risk pool (pool #2) that will not be exposed to any emergency claims arising under the insurance company's risk pool #1. The insurance company has no financial interest in the environmental risk pool #2, but is the third-party beneficiary of all of the risk pool #2 risk reducing and mitigating repair grant events that simultaneously occur during the operation of the risk pool #1 service plan program.

d. Under the method, the retail service plan fee consists of (1) funds to cover the insurance company risk pool #1 emergency repair liability, (2) funds to capitalize the environmental rehabilitation grant fund pool #2, (3) administrative costs, and (4) marketing and sales costs.

e. The end result is that a home receiving an emergency repair fixed and paid for under the insurance company's risk pool #1, will not be a future burden on the environmental rehabilitation risk pool #2. Visa versa, a home receiving a nonemergency inflow, infiltration, exfiltration repair grant paid for (after discovery of the defect through a municipal inspection program) by the environmental risk pool #2, will not become a financial burden on the insurance company's risk pool #1, as a future emergency condition is highly unlikely to occur after the sewer line has been repaired with funds from risk pool #2. Additionally, each time a sewer line is repaired on an emergency basis by the insurance company risk pool #1, it reduces the claim severity and/or frequency upon the current or future environmental fund pool #2.

f. The third step, a municipality-sponsored private sewer service line inspection program, allows the method to work by discovering and revealing defective sewer lateral lines before they have an emergency failure. In essence, going out and looking for potential claims before the sewer line has an emergency breakdown. Defective lines found during the inspection program are paid for out of the environmental rehabilitation risk pool #2 only, as they are nonemergency repairs. Emergency repairs are paid for only by risk pool #1.

g. The method allows the city to proactively inspect private sewer service lines of insured property owners for I/I defects which heretofore may have been restricted or illegal. In other words, a method and its interrelated steps allow the municipality to go into the community and actively look for defective sewer “claims,” a practice uncommon to the property and casualty, service plan or extended warranty insurance industry. Proactively seeking out and uncovering defects, and asking the insurance company to pay under such a nonemergency basis would be an economic and actuarial impossibility for the insurer. The insertion of method step 2 with an independent environmental rehabilitation grant fund covering exposed nonemergency claims allows the method to work effectively over a number of years as grant funds continue to flow into the method.

h. All funds used to provide the solution must be “private funds” and not municipally owned, despite the fact that the funds are solving a municipal legal, environmental and financial problem.

i. Participating property owners agree to contractually allow the municipality to conduct proactive I/I inspections of the property owner's sewer lateral line, after the owner has enrolled in the service plan program on a voluntary, opt-out or mandatory basis.

j. If the inspection reveals that the property owner has a defective sewer lateral line, the municipal inspector requests that the pool #2 trustee issue a repair grant issued on behalf of the participating homeowner to pay the local plumbing company to make the necessary repairs. Other than the cost of the monthly service plan premium, there is no additional out of pocket expense to the property owner to receive the needed repairs, relining or replacement of his private sewer service line. If grant funds have not accumulated enough during the preceding quarter, to cover the cost of the needed repairs, the defective line is put on a repair calendar priority schedule to be repaired when sufficient grant funds are available.

k. Numerous municipal studies have shown that municipal treatment authorities are spending millions of dollars a year processing pure rain water entering their system by inflow and infiltration. In addition to wasting taxpayer dollars, they are using a significant amount of energy resources needlessly to pump and process fresh water as sewage. Waste treatment plants are one of the largest users of energy in a municipality. Depending on the municipality and a number of independent variables, professional research reports have estimated that the all in cost of a municipality to process one gallon of sewage can range from $1.00 to $6.00 per gallon. The method an its interrelated steps lower the municipality's sewage treatment operating costs by reducing the volume of fresh water entering the sanitation system by making repairs to the private side of the sewer infrastructure system.

### BRIEF SUMMARY OF THE INVENTION

The invention is a method whose interrelated steps achieve the required elements for a public/private sector solution that addresses the legal, financial, health and environmental elements of inflow/infiltration and exfiltration risks and exposures to private property owners, municipal governments, sanitation districts and public and/or private sewer utility enterprises.

The method has a structured financial design, process and methodology that allows a municipal and/or private utility sewage treatment entity (city, sewer district or private utility) to offer to its private property owners (residential, multi-family, commercial and industrial), on a voluntary opt-in, voluntary opt-out or mandatory participation basis, an insured private sewer lateral service plan program with a private environmental rehabilitation funds. The method utilizes a private counterbalancing bifurcated risk pool system and methodology for long-term sewer infrastructure rehabilitation. The method will systematically repair, reline, or replace, at no or reduced cost to the participating property owner, with private funds, the property owner's sewer lateral line after a municipality sponsored inflow/infiltration inspection program reveals a defective private lateral line. The inspections and enrollments are performed in the order in which the property owner enrolled into the program.

The methods purpose is to:

(a) reduce inflow and infiltration from the private side of the sewer system infrastructure that will;

(b) reduce wet weather sewage volume at municipal treatment plants, and bio-contamination of subterranean water supplies, by repairing, relining, or replacing the private sewer line from one of two participating and counterbalancing risk pool;

(c) these repairs eventually reducing the frequency and severity of sewer overflows into local public waterways;

(d) simultaneously assisting private property owners with the cost of maintaining their sewer lines;

(e) facilitating and incentivizing a municipality sponsored sewer lateral inspection program,

(e) eventually rehabilitating the private side of the community's sewer infrastructure system to the degree that property owners enroll in the Plan, and

(f) reducing the municipality's operating costs in terms of energy consumption, equipment wear and tear, chemicals, fines and penalties, and man power.

(g) There is no use of municipal funds other than to perform property-owner authorized sewer line inspections within the municipal jurisdiction.

(h) There is no municipal liability under the method.

(i) The municipality announces the availability of the method solution to its private property-owners and the following method steps are implemented:
(1) The private property owners enroll into the plan on a voluntary opt-in, voluntary-opt-out or mandatory enrollment basis as dictated by the sponsoring municipality.
(2) The property owner is billed through his sewer/water bill, or pays the plan fee directly to the plan administrator, or charges it to a credit or debit card on a periodic basis. [e.g. $9.00 per month]
(3) The plan fees are received by the plan administrator who issues the coverage certificate to the property-owner.
(4) The plan administrator establishes a private environmental rehabilitation Grant fund (risk pool #2) for the sponsoring municipality with a local bank trustee or environmental nonprofit agency.
(5) The plan fees are bifurcated internally with approximately 66.5% of the fee [e.g. $6.00 per month] funding the participating insurance company's risk pool (risk pool #1—the underwriter pool) and approximately 33.5% [$3.00 per month] of the plan fee is allocated to the counterbalancing private environmental rehabilitation grant fund (risk pool #2)
(6) When the property owner has an emergency repair claim, that claim is paid out of funds in the underwriter's risk pool #1, up to underwriter's authorized limit.
(7) Simultaneously, on a quarterly or semi-annual basis the sponsoring municipality (who now has permission to enter the property under the terms and conditions of the plan) conducts a proactive inflow/infiltration/exfiltration inspection program of the enrolled property owner's sewer lateral line.
(8) When the municipal inspector discovers a defective enrolled private lateral (which may still be flowing sewage (a non claim event under Pool #1—no emergency) but is severely leaking inward with inflow and infiltration, the inspector will complete a grant repair request and submit it to the environmental fund trustee, who in turn pays the local contractor to repair, reline or replace the defective private sewer lateral at no or low cost to the property owner.
(9) The inspection-originated, nonemergency repairs are funded quarterly or semi-annually until the pool #2 environmental rehabilitation fund is completely exhausted, at which point the inspections will cease. When the fund replenishes from the bifurcated plan fees that continue to flow in subsequent months, the municipal inspection programs begin once again, with the next enrolled property owner in line for an inspection.
(10) Under the bifurcated plan fee structure, pool #1, the underwriter pool is never subjected to claims emanating from the municipal inspection program. Likewise pool #2—environmental repair grant fund is never subjected to emergency claims emanating from property owner sewer emergencies. Emergency claims are only paid out of Pool #1.
(11) The counterbalancing of the plan's method is achieved by the fact that each time the underwriter, using pool #1 funds, relines or replaces a private sewer line emanating from an emergency claim, it represents one less sewer line that may have needed funds from the pool #2 environmental fund. And, every time the inspection program requests that a private sewer line be repaired by the environmental fund trustee out of pool #2, it represents one less potential emergency claim to the underwriter in the future. This counterbalancing of pools #1 and #2, and bifurcating the risk and the plan fees, allow the plan fees to reduce the risk the insurance underwriter, and simultaneously extend the distance the environmental rehabilitation fund pool #2 funds can go in rehabilitating the community's private sewer infrastructure.
(12) The methods impact and results will be:
   (a) the reduction of sewage volume that must be treated,
   (b) the reduction of sanitary sewer overflows,
   (c) the reduction of sewage treatment costs (equipment, wear and tear, chemicals, energy costs and manpower),
   (d) the reduction of bio-contamination of the communities water table,
   (e) the reduction of violations of the Clean Water Act,
   (f) the reduction in sewer line repair costs to the participating property owners, and
   (g) the long-term rehabilitation of the private-side of the community's sewer infrastructure system.

### BRIEF DESCRIPTION OF THE DRAWING

The Figures are flow charts illustrating the steps the present invention performs.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The inventor's method (aka sewer lateral service plan program with environmental rehabilitation grant fund) is a new, proprietary, private sector solution to assist municipal governments and sanitation districts (and municipally contracted private sewer management companies) in addressing their growing challenges in dealing with nonpublic inflow, infiltration, and exfiltration (collectively “I/I”) issues emanating from privately-owned sewer lateral lines.

The method's inventor participated in the original development of one of the first residential “flow” sewer service plan programs introduced to the consumer “home warranty” market place. These commonly used service plan programs are referred to as “flow” programs due to the fact that they only address the sewer lines ability to flow sewage, and do not address or concern themselves in any way with the municipal inflow/infiltration/exfiltration infrastructure crisis. The sewer line's ability to serve as a “sealed” system was not contemplated or addressed under these original flow service/warranty plans.

These traditional sewer lateral service plans that made their way to the market place had several similar characteristics. These “flow” programs, as their name indicates:

(a) had only one primary objective which was to offer maintenance to property owners to remedy their clogged sewer lines on an emergency basis, and

(b) pay for the service call and necessary repairs. The majority of the time, the “repair” provided is the auguring out of the defective sewer line to remove the blockage (roots, encrustation, rodents, and debris) to reestablish the sewage “flow” within the still defective line. Not only will the defective line continue to leak after auguring, it will leak at a higher rate with the walls of the interior pipe scrapped clean. Auguring can also cause additional breaks and cracks in the sewer service line.

An aged, I/I defective private sewer lateral line could be unclogged and made to flow again to satisfy the contractual obligation to the property owner. The fact that the flowing line had I/I issues before or after it was unclogged was not part of the contracted risk unless the lateral line was so collapsed or degraded that it had lost its structural integrity. Private residential sewer lines could be afflicted with I/I symptoms years before and after a qualifying emergency clogging and unclogging event. Unfortunately, the auguring out of a defective sewer line, (the normal procedure utilized by plumbing companies to reestablish sewer line flow), and not address the inflow/infiltration/exfiltration condition of the sewer line, exacerbates and increases the I/I and exfiltration risks to the municipal sanitation district, even though it did remedy the property owner's flow problem.

Sewer experts will suggest that flow only service plan programs can actually exacerbate the municipality's inflow and infiltration crisis. Service plan flow remedies frequently involve the lower cost option of only auguring out the property owner's sewer lateral line. This auguring process removes roots and encrustation from the interior walls of the sewer lateral. The roots and encrustation may in fact be what was keeping more I/I water from entering the line. Scrapping or jetting the interior sewer line walls can actually make the walls more porous and susceptible to more inflow, infiltration and exfiltration. Unless a sewer plan program “revisits” the inflow/infiltration/exfiltration defective sewer line in a systematic fashion, before or after an emergency clogging event, it can actually increase the city's inflow and infiltration problem. Under the inventor's method, “revisiting means a community-wide private sewer lateral inspection program designed to locate and deal with I/I defective private sewer lines, which is the step 3 process of the inventor's methodology.

The method addresses the fact that it is estimated that as many as 45%+ of the private sewer laterals in U.S. cities are aged beyond their expected life, and some as old as 150 years. With private sewer lateral service lines representing as much as 50% of the municipalities sanitation infrastructure, these aging sewer lines contribute significantly to the municipal inflow, infiltration and exfiltration crisis.

(a) The challenge was to create a financially viable methodology and integrated step design that could be developed and effectively implemented in the midst of a deteriorating municipal sewer infrastructure environmental crisis. The method, and its interrelated steps, had to be concurrently:
(1) actuarially viable to the underwriting insurance company,
(2) affordable to the private property owners, and
(3) financially and mathematically supportive of the sponsoring municipality I/I inspection program results.

(b) The inventor's method included the following considerations.
(1) Affordability. Would a solution be affordable to the average property owner?
(2) Profitability. Could an insurance company or administrator enter the relationship in a potentially high risk environment and underwrite a risk it had no obligation to assume, in a profitable manner?
(3) The private interest. Could the property owner's financial interests be addressed?
(4) The public interest: Could the Public's inflow/infiltration/exfiltration legal, financial, public safety, health and environmental interests be addressed?
(5) Time. How much time does the municipality have to provide a viable solution?
(6) Looking for claims. Could a sewer service rehabilitation method be developed that actually went out and proactively looked for defective sewers, and then paid to repair them, with private funds, to solve the municipal inflow/infiltration/exfiltration crisis, with financial viability for all participants, including the insurer, the fund trustee, the property-owner and the sponsoring municipality?

The method and its interrelated and interdependent steps: Inventor created the following methodology.

(a) Counterbalancing risk pools. A step creating two separate and “private” financial pools that had to be operating within the municipality at the same time, and in concert with each other; one covering the private property owner's “flow” interest, and another covering the municipal “inflow/infiltration/exfiltration” interest, with each counterbalancing and actuarially supporting the other within the steps.

(b) A two pool structure. Two separate pools were created as follows:
(1) The method provided for the bifurcation of the sewer service plan's monthly fees paid by the enrolled property owner. The plan fees were divided into pool #1 and pool #2 financial exposures, each independent, but actuarially dependent upon the other.
(2) Pool #1—underwriter's risk pool: This portion of the monthly plan fee (the underwriter's pool) is payable to the underwriter (insurance company and/or third party plan administrator), to cover the private property owner for their unclogging, repairing or replacement of their private sewer lateral originating from an emergency service call event.
(3) Pool #2—environmental rehabilitation grant fund pool: (“ERF”) This portion of the monthly plan fee is administered by, and payable to, a private banking trustee, or nonprofit environmental organization. Pool #2 funds are not subjected to “flow” insurance claims that arose under Pool #1, and are exclusively set aside in the private trust to address and pay for systematic inflow/infiltration/exfiltration inspections, repairing, relining or replacing of I/I defective private lateral lines, at no or low cost to the insured property owner. The ERF is held and administered by any neutral banking, nonprofit or environmental entity.
(4) An alternative method of funding and managing pool #2 funds is to have the insurance company, without a third party, structure pool #2, as (i) a surplus loss reserve, (ii) profit-sharing pool, (iii) retrospective dividend pool, (iv) experience rated fund, (v) a grant or charitable donation funded pool, or (vi) other such similar financial arrangement to cover the cost of I/I inspection-generated nonemergency repairs, separate and apart from the risk pool that pays for emergency breakdown claims.
(5) The attributes of this second pool of funds (the “ERF”) are that it provides private funds to support an environmental inspection program performed by the municipality or private contractor, to camera or smoke or dye test private laterals of insured residents, one at a time, over a period of time, to find I/I defective lines and pay for any needed I/I corrections to the defective line. The ERF is used and depleted, in full, each quarter or semi-annually, until all insured sewer lateral lines have been inspected and repaired.
(6) Supporting and counter balancing risk pools and funds: The method's unique ability to operate in a financially and actuarially viable manner, in an aged sewer lateral environment, is possible due to the financial counter balancing between the two pools of funds.
   (a) Underwriter's pool #1 is exposed to the frequency and severity of the emergency back up claims submitted by participating private property owners. As these are emergency events, they do not originate on a time scheduled basis.
   (b) Pool #2, the environmental rehabilitation fund pool is exposed to a quarterly or semi-annual scheduled inspection program of enrolled private property owners covered under the service plan. Each quarter, as the inspection program reveals I/I defective sewer lateral lines, and pool #2 funds are used to repair, reline or replace the defective lateral line. Each such discovery and repair eliminates a future claim frequency event that would have been payable under the underwriter's pool #1. Pool #1 funds can now handle a higher frequency of emergency claims for a smaller monthly fee, in a challenged and aged lateral environment due to the risk absorption functionality of risk pool #2.
   (c) Pool #2, the ERF, conversely has its funds go further as the insurer or administrator repairs, relines or replaces defective sewer lines using claim funds from Pool #1.
   (d) The underwriter's risk pool #1 portion of the method, will not reline or replace a defective line, when the condition of the line is not under an emergency blockage condition.
   (e) Therefore, the private lines repaired or relined under the underwriter's pool #1,
      (i) allows the funds of the pool #2 environmental rehabilitation funds to go further as they are utilized on the remaining properties enrolled in the program, and
      (ii) expands the available funds to continue to perform more inspections and repairs.
(7) The collective embodiment of the inventor's method, in non technical terms, is identified as “a private sewer lateral insured service plan program with environmental rehabilitation grant fund.
The plan's risk pool #1 may be financially guaranteed by
   (a) an insurance company,
   (b) financially guaranteed by a third party administrator, or
   (c) financially insured or reinsured by a service plan contractual liability insurance policy.
The plan's risk pool #2, the environmental rehabilitation fund may be funded and capitalized through a variety of internal or external funding mechanisms including but not limited to:
   (a) bifurcated service plan fee disbursements,
   (b) retrospective profit sharing arrangements,
   (c) insurance premium surplus reserve funds,
   (d) surplus and/or loss reserve accounts, funds or pools,
   (e) private trustee grants, endowments or gifts structures,
   (f) reinsurance,
   (g) risk retention relationships,
   (h) experience rated dividends
   (i) public state or federal stimulus or environmental funds or grants, or other similar funding mechanisms.
   (8) The inventor's method also embodies variations and expanded coverage versions of the program that may included coverage for (i) private fresh water supply lines on the private property owner's property, and (ii) sewage grinder pump coverage. The identity of the plan would then be identified as “sewer and water service plan program with environmental rehabilitation fund,” or a number of variations thereof.
   (9) The inventor's method may have insurance backed underwriting for risk pool #1 in which case the embodiment of the inventor's method would be identified as “an insured sewer line service plan program with environmental rehabilitation fund.”
   (10) The embodiment of the Inventors design, methodology and system may be described in a number of identifying names which may or may not disclose or reveal all of the inventor's methodological steps, proprietary attributes, configurations, design, system or utilizations, including but not limited to;
      (a) sewer line service plan
      (b) sewer lateral service plan
      (c) sewer and water service plan
      (d) insured sewer line service plan
      (e) insured sewer service plan w/environmental rehabilitation fund
      (f) sewer line service plan w/environmental rehabilitation fund
      (g) insured sewer lateral service plan
      (h) insured sewer lateral service plan w/environmental rehabilitation
      (i) private sewer lateral service plan
      (j) sewer lateral service plan w/environmental rehabilitation fund
      (k) versions (e), (f), (h) and (j) above with “rehabilitation grant fund”
      (l) or any various thereof above
   Note: the words or terms (1) sewer restoration fund, (2) sewer inspection fund, (3) sewer repair fund, (4) maintenance, (5) repair, (6) water, (7) service (8) municipal and (9) sponsored, along with other descriptive terms describing the pool #2 attributes affording inflow/infiltration/exfiltration repair funds to restore private sewer lateral lines are contemplated in the method and its interrelated steps.

The method's unique and first-of-its-kind distinguishing steps embodied in the method's financial structuring and solution, addressing the inflow/infiltration/exfiltration issues facing participating municipalities include.

(a) a segregated environmental rehabilitation fund pool: As described above, the pool #2 fund, is a separate trust account established for each participating community. The funds generated from one community's program are isolated into a separate trust account. At no time are funds commingled or utilized in conjunction with any other program. If other funding methods are used they are likewise not commingled.

(b) trust administrator: The plan administrator engages a commercial bank, or a nonprofit organization that promotes environmental stewardship, or a third party fiduciary entity to administer the environmental rehabilitation fund distribution of funds to pay for the inflow/infiltration/exfiltration repairs discovered during the municipal inspection program step. (pool #2—municipal inspection program)

(c) conducting the inspections of private residential laterals: The following are the method step design requirements for the pool #2 funded inspection segment of the method.
(1) The inspection design method step: The inspection is (a) the camera viewing or smoke or dye testing of the insured private sewer lateral line from the cleanout at the foundation of the home to the public connection point, or from the main sewer line inward to the building's foundation line (b) a determination that downspouts and yard drains are not flowing into the sewer lateral line, and (c) making sure the cleanout has a proper cap mechanism.
(2) The Inspector: The inspector is looking for major sources of inflow, infiltration and exfiltration such as missing sidewall sections, collapsed laterals, missing parts, illegal connections, cracks, leaks, disjointed sections, root incursion and deteriorated structural performance.
(3) Emergency service claims: Any property owner who is enrolled in the program is entitled to receive the benefits of the program. Every enrolled property owner who pays the plan's monthly fee is automatically covered for the underwriter's risk pool #1 emergency service coverage, after a prescribed elimination period, which includes auguring, repair, relining or full or partial line section replacement if necessary depending on the condition of the line at the time of the emergency service call.
(4) Inspection originated service claims: In order to receive the benefits of the environmental rehabilitation funds from pool #2, the property owner must be enrolled in the program at the time their property is selected for inspection. Inspections begin with the order in which property owners enrolled in the plan, starting with the date the first property owner enrolled. As soon as the pool #2 inspection repair fund begins to accumulate meaningful funds (3 to 6 months), the pool #2 trustee will start coordinating the inspection/repair program arrangements with the municipal inspector and retain local contractors to make the necessary repairs with the property owner's permission, at no cost to the property owner. For participating in the program, the property owner receives a no cost (other than the premium paid) repair or replacement of his defective sewer lateral line from pool #2 funds. The sponsoring municipality may elect to speed up the rehabilitation process and extend the available pool #2 funds by asking the participating homeowners to bear a portion of the nonemergency repair costs to accelerate the programs impact within the community depending on the degree of the severity of the community's financial, environmental, legal compliance and health crisis.

The method's implementation steps:
(a) Plan sponsorship: The plan sponsor is a public entity responsible in some manner for sewage or water services, treatment, or environmental matters within the community.
   (1) Determining the program type: The municipal sponsor first selects one of three implementation methodologies. There are 3 methods.
      (a) Voluntary opt-in: The property owner is solicited to enroll in the plan on a voluntary basis. If the property owner elects to opt into the plan, indemnification begins after an initial elimination period (30, 60 or 90 days).
      (b) Voluntary opt-out: All property owners are automatically enrolled in the program and the program's bifurcated fee is added to their sewer/water monthly or quarterly billing by the sponsoring municipality. An environmental educational program step is attached to make the community aware of the serious inflow/infiltration/exfiltration issues and how staying in the plan can be financially beneficial to them and protect the environment and reduce treatment costs at the same time. Property owners are given some number of days to opt-out (30, 60, 90 or 120 days) by (1) returning the opt-out post card declining indemnification, (2) opting-out on the city website or the insurer website, or (3) calling the plan customer service center asking that the program be removed from their billing statement.
      (c) Mandatory: In some jurisdictions, municipalities can invoke certain emergency powers due to the crisis-stage inflow/infiltration/exfiltration environmental condition that exist within the municipality, wherein the sewer treatment authority or city administrators may elect to add the plan coverage and method to all property owner sewer or water bills as an additional mandated fee.
         All of the implementation methods will reduce the inflow/infiltration and exfiltration conditions within the community to varying degrees based upon participation.

Use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. All specialized terms and words of art reflecting insurance or financial service industry terms, (e.g. “experience rated dividend”, “retrospective profit sharing,” “risk retention group”, etc.) shall be defined and interpreted within the standard usage within their respective industry.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

What is claimed is:

1. A method utilizing private bifurcated counter-balancing risk pools to reduce a public sanitation authority's financial and legal liability caused by defective, privately-owned sewer lateral service lines, the steps comprising:
creating a private, public entity sponsored, sewer repair indemnification program for owners of private sewer lateral service lines;
creating a third-party indemnified risk pool (pool #1) to pay for the emergency breakdown and repair of enrolled private sewer lateral service lines,
further creating a second, privately-held, risk pool (pool #2) to cover nonemergency repairs of defective private sewer lateral lines discovered during municipal inspections;
and incorporating a municipal sewer lateral inspection program to inspect privately-owned sewer lines for inflow, infiltration, exfiltration defects and improper connections.

2. A method of claim 1 with a step establishing the third-party indemnified pool #1 with private funds from a service plan, warranty, extended warranty, terms and conditions certificate, direct indemnification insurance policy, a contractual liability insurance policy, corporate guarantee, risk retention group, or reinsurance.

3. A method of claim 1 further comprising the step of establishing pool #2 with private funds from bifurcated premiums, bifurcated fees, retrospective profit sharing, loss reserves, contingency loss reserves, experience rated dividends, surplus reserve funds, reinsurance, insurance, commissions, gifts or grants.

4. A method of claim 3 with a step utilizing pool #2 funds to lower the loss frequency of the third-party indemnified underwriter pool #1 by paying for the repair of defective sewer lines discovered during the inspection process, before the defective lines manifest themselves into an emergency breakdown condition.

5. A method of claim 2 with a step wherein pool #1 funds are used to lower the loss frequency of the environmental repair pool #2 by paying for repairs of private sewer lines experiencing emergency breakdown conditions, prior to or after municipal inspection.

6. A method of claim 1 further comprising the step of providing municipalities and/or their contracted inspector, with contractual authorization to conduct an inspection of the indemnified private sewer line with the property owner's consent which is authorized under the terms and conditions of the indemnification plan, which heretofore the municipality may have not had the authority to perform.

7. A method of claim 2 comprising of the step of paying out of pool #1 funds for the emergency repair costs for work performed on enrolled private sewer lines experiencing an emergency breakdown of the enrolled sewer lines prior to or after the municipal inspection program to reduce the amount of inflow, infiltration and exfiltration from the subject line.

8. A method of claim 3 comprising of the step of paying for nonemergency repairs for work performed on enrolled, inflow, infiltration, exfiltration defective, sewer lines detected through a municipal inspection program to reduce the amount of inflow, infiltration and exfiltration from the subject line.
